(19) United States
(12) Patent Application Publication
(10) Pub. No.: US 2018/0134066 A1
(43) Pub. Date: May 17, 2018

(54) Ink Pen Assembly

(71) Applicant: Mark Gabourel, Hawthorne, CA (US)

(72) Inventor: Mark Gabourel, Hawthorne, CA (US)

(21) Appl. No.: 15/352,752

(22) Filed: Nov. 16, 2016

(51) Int. Cl. B43K 29/00; B05C 17/005; B43M 11/02

(52) U.S. Cl. CPC B43K 29/00; B43M 11/02; B05C 17/00596; B05C 17/00516

(57) ABSTRACT

An ink pen assembly for selectively moistening an adhesive includes a pen that is selectively manipulated thereby facilitating the pen to write. A moistening unit is removably coupled to the pen. The moistening unit contains a liquid thereby facilitating the moistening unit to selectively release the liquid onto a liquid activated adhesive.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to pen devices and more particularly pertains to a new pen device for writing and selectively moistening an adhesive.

### BRIEF SUMMARY OF THE INVENTION

An embodiment of the disclosure meets the needs presented above by generally comprising a pen that is selectively manipulated thereby facilitating the pen to write. A moistening unit is removably coupled to the pen. The moistening unit contains a liquid thereby facilitating the moistening unit to selectively release the liquid onto a liquid activated adhesive.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an ink pen assembly according to an embodiment of the disclosure.

FIG. 2 is an exploded perspective view of an embodiment of the disclosure.

FIG. 3 is an exploded perspective view of a second cylinder of an embodiment of the disclosure.

FIG. 4 is a cross sectional view taken along line 4-4 of FIG. 1 of an embodiment of the disclosure.

### DETAILED DESCRIPTION OF THE INVENTION

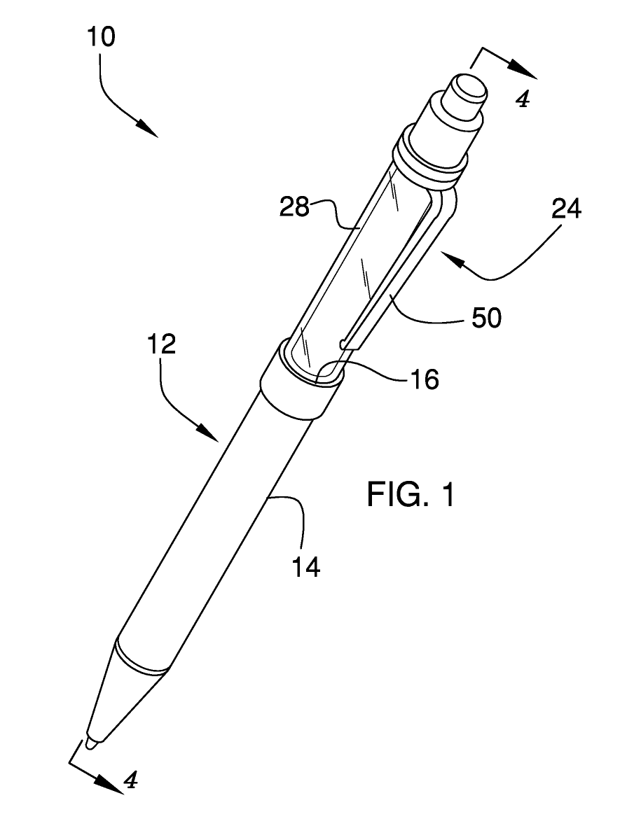

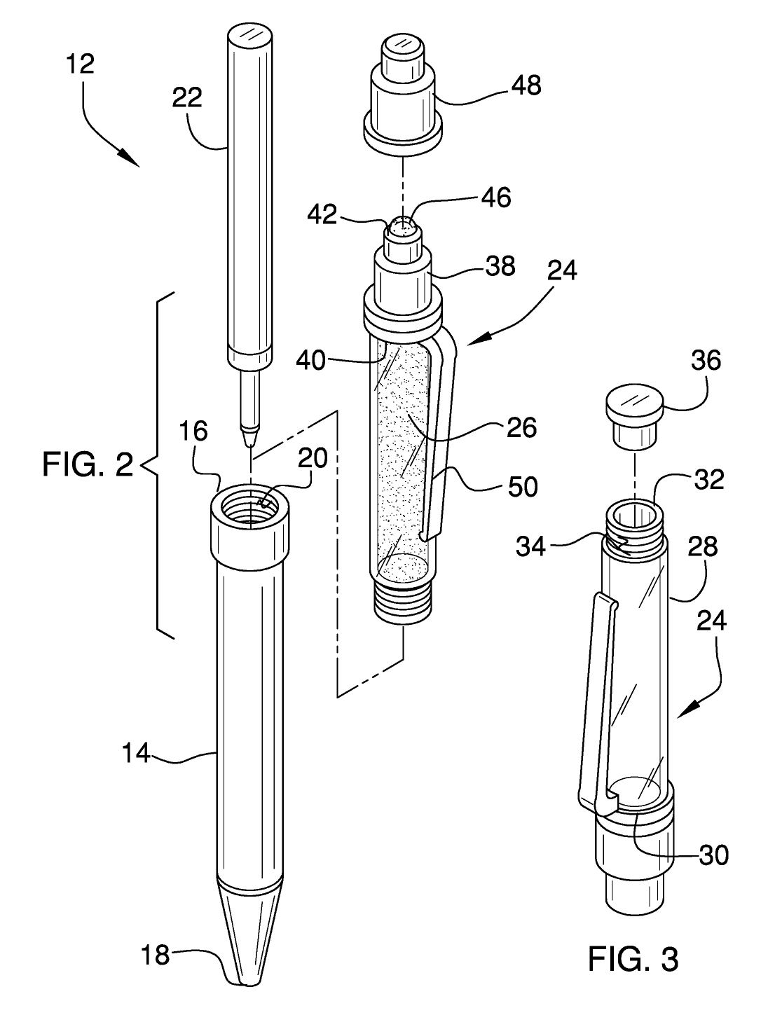

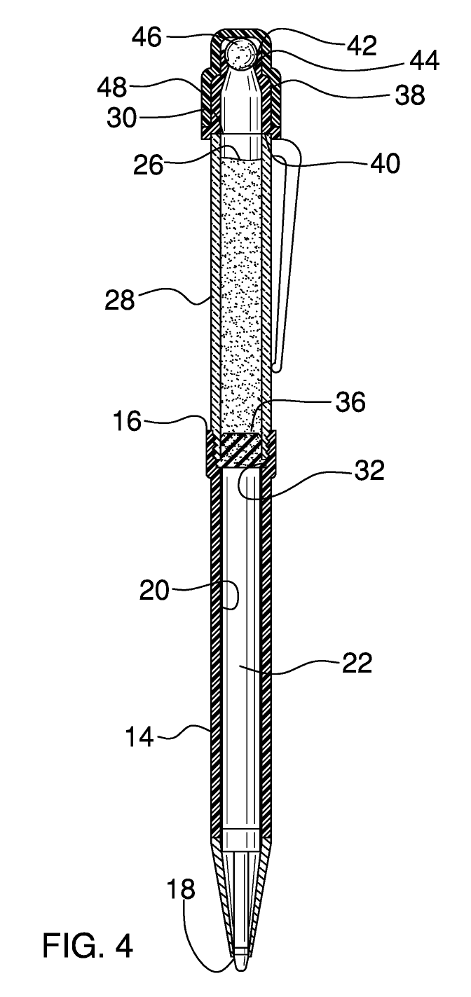

With reference now to the drawings, and in particular to FIGS. 1 through 4 thereof, a new pen device embodying the principles and concepts of an embodiment of the disclosure and generally designated by the reference numeral 10 will be described.

As best illustrated in FIGS. 1 through 4, the ink pen assembly 10 generally comprises a pen 12 that may be manipulated thereby facilitating the pen 12 to write. The pen 12 comprises a first cylinder 14 that has a top end 16 and a bottom end 18. Each of the top end 16 and the bottom end 18 are open and the first cylinder 14 is substantially hollow. The first cylinder 14 may taper to a point at the bottom end 18 and the cylinder has an interior surface 20. The interior surface 20 may be threaded adjacent to the top end 16.

An ink cartridge 22 is provided and the ink cartridge 22 contains a fluid ink. The ink cartridge 22 is selectively inserted into the first cylinder 14 to selectively release the fluid ink onto a surface thereby facilitating the pen 12 to write. The surface may be a piece of paper or other surface commonly written on with an ink pen 12. The ink cartridge 22 may be a ball point pen cartridge of any conventional design.

A moistening unit 24 is provided and the moistening unit 24 is removably coupled to the pen 12. The moistening unit 24 contains a liquid 26 thereby facilitating the moistening unit 24 to selectively release the liquid 26 onto a liquid activated adhesive. The liquid 26 may be water and the liquid activated adhesive may be an adhesive strip on an envelope or the like.

The moistening unit 24 comprises a second cylinder 28 that has an upper end 30 and a lower end 32. Each of the upper end 30 and the lower end 32 are open and the second cylinder 28 is substantially hollow to contain the liquid 26. The lower end 32 selectively engages the top end 16 of the first cylinder 14. The second cylinder 28 has an outer surface 34 and the outer surface 34 may be threaded adjacent to the lower end 32. Thus, the outer surface 34 may threadably engage the interior surface 20 of the first cylinder 14. Additionally, the second cylinder 28 is comprised of a translucent material thereby facilitating the liquid level in the second cylinder 28 to be visible.

A plug 36 is provided and the plug 36 is removably positioned in the lower end 32. The plug 36 forms a fluid impermeable seal with the second cylinder 28 to inhibit the liquid 26 from escaping through the lower end 32. The plug 36 may be comprised of a resiliently compressible material such as rubber or the like.

A dispenser 38 is provided that has a first end 40 and a second end 42. Each of the first end 40 and the second end 42 are open and the dispenser 38 is substantially hollow. The first end 40 is coupled to the upper end 30 of the second cylinder 28 such that the dispenser 38 is in fluid communication with an interior of the second cylinder 28. The dispenser 38 has an inner surface 44.

A ball 46 is provided and the ball 46 is rotatably positioned in the second end 42 of the dispenser 38 having the ball 46 partially extending outwardly from the second end 42. The ball 46 engages the inner surface 44 of the dispenser 38 such that the ball 46 is retained in the second end 42. Moreover, the ball 46 is comprised of a fluid permeable material to selectively release the liquid 26 onto the liquid activated adhesive when the pen 12 is manipulated to roll the ball 46 on the liquid activated adhesive.

A cap 48 is provided and the cap 48 is removably coupled to the dispenser 38. The cap 48 covers the ball 46 when the cap 48 is positioned on the dispenser 38 to inhibit the liquid 26 from escaping the dispenser 38. A clip 50 is coupled to the second cylinder 28 and the clip 50 extends downwardly along the second cylinder 28. The clip 50 may releasably engage an article of clothing or the like to retain the pen 12 on the article of clothing.

In use, the second cylinder 28 is removed from the first cylinder 14 and the plug 36 is removed from the lower end 32. The liquid 26 is poured into the lower end 32 and the plug 36 is placed in the lower end 32 when the first cylinder 14 is filled with the liquid 26. The second cylinder 28 is coupled to the first cylinder 14 and the pen 12 is manipulated in the convention of writing. The cap 48 is removed from the second cylinder 28 and the ball 46 is rolled along the liquid 26 activated adhesive. The liquid 26 is released onto the liquid 26 activated adhesive and the liquid 26 activated adhesive is activated without licking or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An ink pen assembly being configured to selectively moisten an adhesive strip on an envelope, said assembly comprising:
a pen being configured to be manipulated thereby facilitating said pen to write, said pen including a first cylinder, said first cylinder having a top end and a bottom end, each of said top end and said bottom end being open, said first cylinder being substantially hollow; and
a moistening unit being removably coupled to said pen, said moistening unit being configured to contain a liquid thereby facilitating said moistening unit to selectively release the liquid onto a liquid activated adhesive, said moistening unit including a second cylinder having an upper end and a lower end, each of said upper end and said lower end being open, said second cylinder being substantially hollow wherein said second cylinder is configured to contain the liquid, said lower end selectively engaging said top end of said first cylinder, said second cylinder being translucent such that a level of the liquid in said second cylinder is visible.

2. (canceled)

3. The assembly according to claim 1, further comprising an ink cartridge being configured to contain a fluid ink, said ink cartridge being selectively inserted into said first cylinder wherein said ink cartridge is configured to selectively release the ink onto a surface thereby facilitating said pen to write.

4. (canceled)

5. The assembly according to claim 1, further comprising a plug being removably positioned in said lower end, said plug forming a fluid impermeable seal with said second cylinder wherein said plug is configured to inhibit the liquid from escaping through said lower end.

6. The assembly according to claim 1, further comprising a dispenser having a first end and a second end, each of said first end and said second end being open, said dispenser being substantially hollow, said first end being coupled to said upper end of said second cylinder such that said dispenser is in fluid communication with an interior of said second cylinder, said dispenser having an inner surface.

7. The assembly according to claim 6, further comprising a ball being rotatably positioned in said second end of said dispenser having said ball partially extending outwardly from said second end, said ball engaging said inner surface of said dispenser such that said ball is retained in said second end.

8. The assembly according to claim 7, wherein said ball is comprised of a fluid permeable material wherein said ball is configured to selectively release the liquid onto the liquid activated adhesive when said pen is manipulated to roll said ball on the liquid activated adhesive.

9. The assembly according to claim 8, further comprising a cap being removably coupled to said dispenser such that said cap covers said ball wherein said cap is configured to inhibit the liquid from escaping said dispenser.

10. An ink pen assembly being configured to selectively moisten an adhesive strip on an envelope, said assembly comprising:
a pen being configured to be manipulated thereby facilitating said pen to write, said pen comprising:
a first cylinder having a top end and a bottom end, each of said top end and said bottom end being open, said first cylinder being substantially hollow, and
an ink cartridge being configured to contain a fluid ink, said ink cartridge being selectively inserted into said first cylinder wherein said ink cartridge is configured to selectively release the ink onto a surface thereby facilitating said pen to write; and
a moistening unit being removably coupled to said pen, said moistening unit being configured to contain a liquid thereby facilitating said moistening unit to selectively release the liquid onto a liquid activated adhesive, said moistening unit comprising:
a second cylinder having an upper end and a lower end, each of said upper end and said lower end being open, said second cylinder being substantially hollow wherein said second cylinder is configured to contain the liquid, said lower end selectively engaging said top end of said first cylinder, said second cylinder being translucent such that a level of the liquid in said second cylinder is visible,
a plug being removably positioned in said lower end, said plug forming a fluid impermeable seal with said second cylinder wherein said plug is configured to inhibit the liquid from escaping through said lower end,
a dispenser having a first end and a second end, each of said first end and said second end being open, said dispenser being substantially hollow, said first end being coupled to said upper end of said second cylinder such that said dispenser is in fluid communication with an interior of said second cylinder, said dispenser having an inner surface,
a ball being rotatably positioned in said second end of said dispenser having said ball partially extending outwardly from said second end, said ball engaging said inner surface of said dispenser such that said ball is retained in said second end, said ball being comprised of a fluid permeable material wherein said ball is configured to selectively release the liquid onto the liquid activated adhesive when said pen is manipulated to roll said ball on the liquid activated adhesive, and
a cap being removably coupled to said dispenser such that said cap covers said ball wherein said cap is configured to inhibit the liquid from escaping said dispenser.
